(19) United States
(12) Patent Application Publication
(10) Pub. No.: US 2013/0120668 A1
(43) Pub. Date: May 16, 2013

(54) IMAGE PROJECTION SYSTEM AND CONTROL METHOD FOR THE IMAGE PROJECTION SYSTEM

(71) Applicant: Yuki Ueda, Matsumoto-shi (JP)

(72) Inventor: Yuki Ueda, Matsumoto-shi (JP)

(73) Assignee: Seiko Epson Corporation, Tokyo (JP)

(21) Appl. No.: 13/297,592

(22) Filed: Nov. 16, 2011

(51) Int. Cl. H04N 9/31; G09G 5/00

(52) U.S. Cl. 348/744; 345/633; 348/E09.025

(57) ABSTRACT

In at least one embodiment of the disclosure, an image projection system includes an image supply device and a projector. The image projection system projects an image of a figure adapted to represent a predetermined record in a competition on a floor or a ground of a stadium. The image supply device further includes a storage section adapted to store record information representing the predetermined record, and an image data output section adapted to output image data based on the record information to the projector. The projector includes an image data input section adapted to receive input of the image data, and an image projection section adapted to project the image of the figure based on the image data input to the image data input section.

### TECHNICAL FIELD

The present invention relates to an image projection system, and a method of controlling an image projection system.

### BACKGROUND ART

In recent years, there have been some cases in which a line of a record such as a world record or a Japanese record is displayed on a screen together with an athlete in a competition when watching the competition of, for example, swimming on television. If the record line is displayed on the screen as described above, the viewer watching the competition on television can visually recognize the competition state of the athlete and the record line in contrast with each other, and can therefore fascinatingly watch and thus enjoy the competition while considering whether or not a new record is achieved.

Patent Literature 1 discloses an image processing method for a sport competition of flying athletic equipment to a desired location such as golf or a sport competition for the athlete to reach a predetermined location such as ski jumping, which superimposes a mark image such as a line or a figure due to an electronic image processing on the vicinity of the location to which the athletic equipment is flown or the location where the athlete reaches in the image of the competition.

### CITATION LIST

### Patent Literature

[Patent Literature 1] JP-A-2005-159385

### SUMMARY OF INVENTION

### Problems that the Invention is to Solve

However, the audience watching the competition not on television but in a stadium is not allowed to view the record line, and is therefore not allowed to watch and enjoy the competition while comparing the competition state of the athlete and the record line with each other. Further, it is not allowed for the audience watching the competition in the stadium to recognize whether or not a new record has been achieved until the measurement result is issued after the competition ends.

### Means for Solving the Problems

The invention is made for solving at least a part of the problem described above, and can be realized as the following aspects and application examples.

### Application Example 1

An image projection system according to the present application example is an image projection system including an image supply device and a projector and for projecting an image of a figure adapted to represent a predetermined record in a competition on a floor or a ground of a stadium, the image supply device further including a storage section adapted to store record information representing the predetermined record, and an image data output section adapted to output image data based on the record information to the projector, and the projector including an image data input section adapted to receive input of the image data, and an image projection section adapted to project the image of the figure based on the image data input to the image data input section.

According to such an image projection system, there are provided the image supply device and the projector, and the image projection system projects the image of the figure adapted to represent a predetermined record in the competition on the floor or the ground of the stadium. The image supply device has a storage section and an image data output section. The storage section stores the record information representing the predetermined record. The image data output section outputs the image data based on the record information to the projector. The projector has an image data input section and an image projection section. The image data input section inputs the image data, and the image projection section projects the image of the figure based on the image data. In other words, the image supply device outputs the image data representing the predetermined record in the competition to the projector, and then the projector projects the figure on the floor or the ground of the stadium based on the image data. Thus, by viewing the figure projected by the projector, the audience watching the competition in the stadium can recognize the predetermined record (e.g., the world record). In other words, it becomes possible for the audience of the competition to advantageously watch and enjoy the competition while comparing the competition state of the athlete and the predetermined record with each other. Further, it becomes possible for the audience of the competition to recognize whether or not the predetermined record is broken without waiting until the measurement result is issued after the competition by comparing the athletes and the figure with each other.

### Application Example 2

In the image projection system according to the application example described above, the image supply device further includes a start signal input section to which a start signal indicating start of projection of the figure is input, and a control section adapted to make the image data output section start output of the image data upon input of the start signal to the start signal input section.

According to such an image projection system, the image supply device further includes a start signal input section and a control section. When the start signal representing the start of the projection of the figure is input in conjunction with the progress of the competition, the control section makes the image data output section start to output the image data. In other words, if the start signal is input, the image supply device start to output the image data, and the projector projects the figure on the floor or the ground of the stadium based on the image data. Thus, it becomes possible for the audience watching the competition in the stadium to advantageously watch the competition while comparing the competition state of the athlete and the figure representing the predetermined record with each other taking the start signal interlocking with the progress of the competition as a trigger. For example, it can also be applied to the competition requiring strict timing such as the short-distance sprint.

### Application Example 3

In the image projection system according to the application example described above, the record information stored in the storage section of the image supply device is a video data of the figure representing a midway progress and a result of the predetermined record in the competition, and the image data output section outputs the video data to the projector as the image data.

According to such an image projection system, the record information is the video data representing the midway progress and the result of the predetermined record in the competition. The image supply device outputs the image data as the video data, and the projector projects the figure on the floor or the ground of the stadium based on the image data. Thus, it becomes possible for the audience watching the competition in the stadium to advantageously watch the competition while comparing the competition state (the state during the competition) of the athlete and the video of the figure representing the midway progress and the result of the predetermined record with each other. Further, it becomes possible for the audience of the competition to recognize whether or not the predetermined record is broken without waiting until the measurement result is issued after the competition by comparing the athletes and the figure with each other.

### Application Example 4

In the image projection system according to the application example described above, the record information stored in the storage section of the image supply device is progress record information representing a midway progress and a result of the predetermined record in the competition, the image supply device further includes an image generation section adapted to generate video data of the figure representing the midway progress and the result of the predetermined record in the competition based on the progress record information stored in the storage section, and the image data output section outputs the video data generated by the image generation section to the projector as the image data.

According to such an image projection system, the progress record information as the information of the predetermined record is stored in the storage section of the image supply device as the record information. The image generation section generates the video image of the figure based on the progress record information. The image data output section outputs the video data generated by the image generation section to the projector. The projector projects the image of the figure based on the image data input thereto. In other words, the image supply device generates the image data from the record information of the predetermined record in the competition, and then outputs the image data to the projector. The projector projects the figure on the floor or the ground of the stadium based on the image data. Thus, by viewing the figure projected by the projector, the audience watching the competition in the stadium can recognize the predetermined record (e.g., the world record). In other words, it becomes possible for the audience of the competition to advantageously watch the competition while comparing the competition state of the athlete and the predetermined record with each other. Further, it becomes possible for the audience of the competition to recognize whether or not the predetermined record is broken without waiting until the measurement result is issued after the competition by comparing the athletes and the figure with each other.

### Application Example 5

In the image projection system according to the application example described above, the image of the figure is an image of a line.

According to such an image projection system, the image of the figure is the image of a line. In other words, the image supply device outputs the line image data representing the predetermined record, and then the projector projects the line, namely the “line” on the floor or the ground of the stadium based on the line image data. Thus, by viewing the line projected by the projector, the audience watching the competition in the stadium can recognize the predetermined record. In other words, it becomes possible for the audience of the competition to advantageously watch the competition while comparing the competition state of the athlete and the line of the predetermined record with each other. Further, it becomes possible for the audience of the competition to recognize whether or not the predetermined record is broken without waiting until the measurement result is issued after the competition by comparing it with the line.

### Application Example 6

A method of controlling an image projection system according to the present application example is a method of controlling an image projection system including an image supply device and a projector, the image supply device including a storage section adapted to store record information representing a predetermined record in the competition, and the image projection system projecting an image of a figure adapted to represent the predetermined record based on image data based on the record information on a floor or a ground of a stadium, the method including an image data output step in which the image supply device outputs the image data based on the record information to the projector, an image data input step in which the projector receives input of the image data, and an image projection step in which the projector projects the image of the figure based on the image data input by the image data input step.

According to such a method of controlling the image projection system, the image supply device outputs the image data based on the record information representing the predetermined record in the competition to the projector, and then the projector projects the figure on the floor or the ground of the stadium based on the image data thus input. Thus, by viewing the figure projected by the projector, the audience watching the competition in the stadium can recognize the predetermined record. In other words, it becomes possible for the audience of the competition to advantageously watch and enjoy the competition while comparing the competition state of the athlete and the predetermined record with each other. Further, it becomes possible for the audience of the competition to recognize whether or not the predetermined record is broken without waiting until the measurement result is issued after the competition by comparing the athletes and the figure with each other.

### BRIEF DESCRIPTION OF THE DRAWINGS

FIG. 1 is an explanatory diagram of a stadium where an image projection system according to a first embodiment projects an image of a line of the world record.

FIG. 2 is a block diagram showing a schematic configuration of an image supply device and a projector.

FIG. 3 is a block diagram showing a schematic configuration of an image projection system according to a second embodiment.

FIG. 4 is an explanatory diagram of progress record information wherein (a) is a table storing an athletic event and the world record time, and (b) is a table storing the progress information of the competition.

FIG. 5 is an explanatory diagram of a stadium of the long jump where an image projection system according to a third embodiment projects an image of a line of the world record.

FIG. 6 is a block diagram showing a schematic configuration of an image supply device and a projector.

### MODE FOR CARRYING OUT THE INVENTION

Hereinafter, some embodiments of the invention will be explained.

### First Embodiment

In the first embodiment, an image projection system for projecting an image of a line representing the world record as a predetermined record in the 100-meter dash on the ground will be explained.

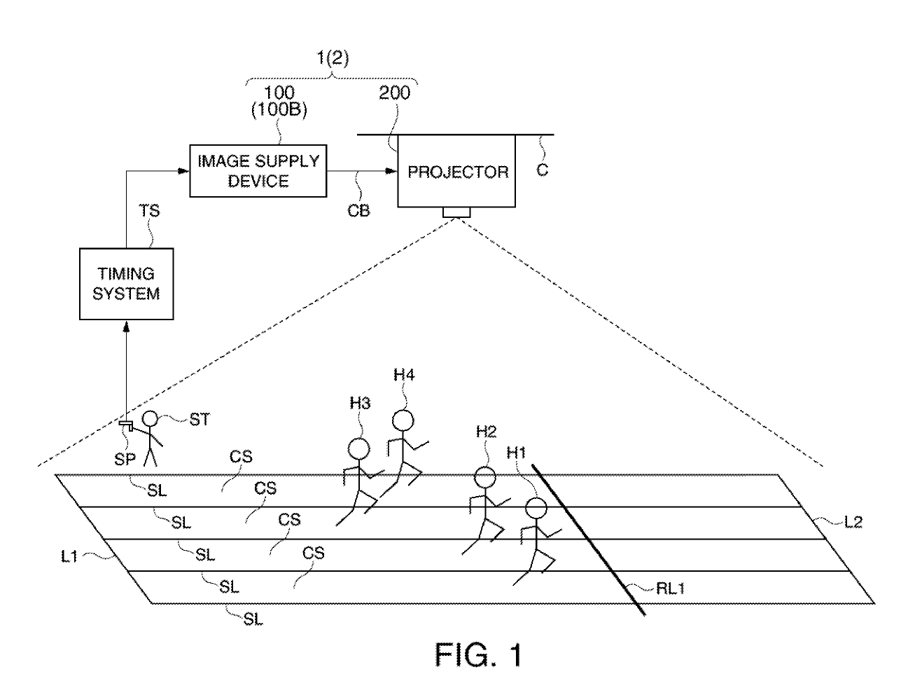

FIG. 1 is an explanatory diagram of a stadium where an image projection system according to the first embodiment projects an image of a line of the world record. As shown in FIG. 1, the image projection system 1 according to the present embodiment is composed of an image supply device 100 and a projector 200. Further, outside the image projection system 1, there are shown a starting pistol SP held by a starter ST and a timing system TS. Further, FIG. 1 shows a line (hereinafter referred to as a “record line RL1”) indicating the world record, a start line L1, separate lanes SL for indicating tracks CS, a finish line L2, and athletes H1, H2, H3, and H4 running on the tracks CS.

In the present embodiment, it is assumed that the stadium is an indoor athletics stadium, and the separate lanes SL, the start line L1, and the finish line L2 are disposed on the ground. The athletes H1, H2, H3, and H4 start from the start line L1 taking the sound of the starting pistol SP held by the starter ST as a cue, and then run on the tracks CS toward the finish line L2.

The starting pistol SP held by the starter ST transmits an electrical start signal to the timing system TS. The timing system TS starts timing upon reception of the start signal. Further, the timing system TS outputs the start signal to the image supply device 100.

Upon receiving the input of the start signal, the image supply device 100 outputs the image data of the record line RL1 to the projector 200 via a cable CB. The projector 200 projects the image of the record line RL1 on the tracks CS based on the image data of the record line RL1 thus input. It should be noted that the projector 200 is installed to the ceiling C of the stadium so as to face to the ground, and is arranged to be able to project an image on the tracks CS from the start line L1 to the finish line L2 of the stadium.

As shown in FIG. 1, the record line RL1 is a line perpendicular to the separate lanes SL. The image data of the record line RL1 is assumed to be the video data created based on the running record (the midway progress and the result) of the world record holder of the 100-meter dash from start to finish thereof. Therefore, the record line RL1 continues to be displayed in the period from start to finish of the world record holder while moving on the tracks CS.

It should be noted that it is also possible to install a plurality of projectors 200 to the ceiling C to thereby project the record line RL1. By installing the plurality of projectors 200 to the ceiling C so that the projection ranges adjacent to each other overlap each other, the record line RL1 can more clearly be displayed.

As described above, the image projection system 1 is capable of projecting the record line RL1 indicating the midway progress and the result of the world record of the athletic event on the tracks CS.

Then, the image supply device 100 and the projector 200 provided to the image projection system 1 according to the present embodiment will be explained.

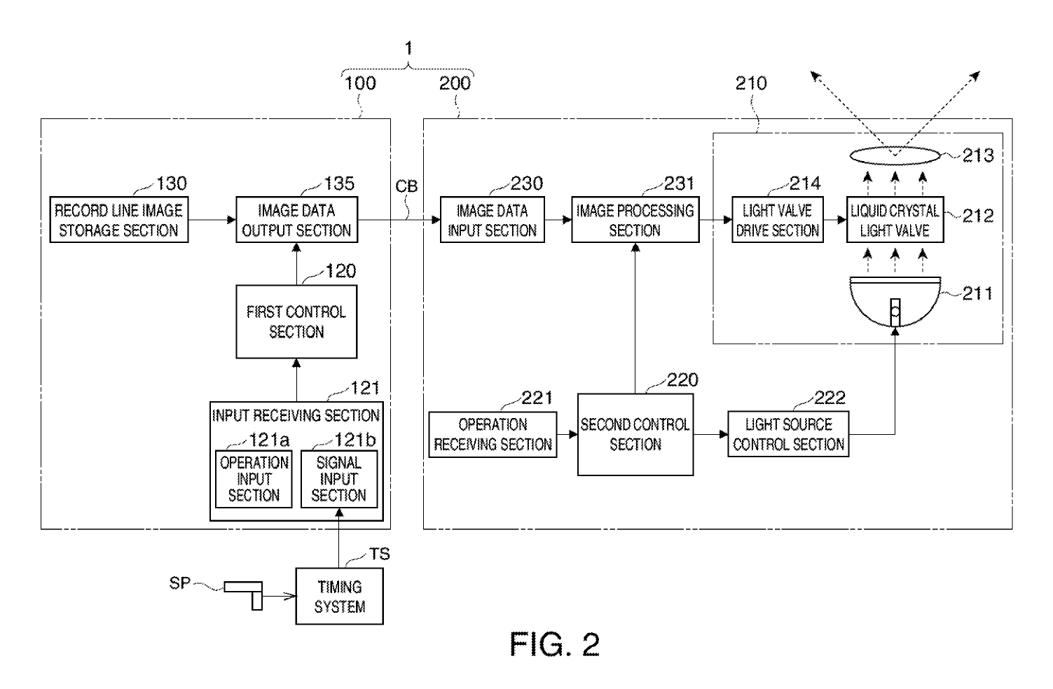

FIG. 2 is a block diagram showing a schematic configuration of the image supply device 100 and the projector 200 according to the present embodiment. The internal configuration of the image supply device 100 and the projector 200 will be explained using FIG. 2.

The image projection system 1 is provided with the image supply device 100 and the projector 200. In FIG. 2, there are further shown the starting pistol SP for transmitting the start signal to the image projection system 1, and the timing system TS.

The image supply device 100 is provided with a first control section 120, an input receiving section 121, a record line image storage section 130 as a storage section, an image data output section 135, and so on. It should be noted that the image supply device 100 can be a personal computer or the like provided with such constituents.

The first control section 120 is provided with a CPU (Central Processing Unit), a RAM (Random Access Memory) used as, for example, a temporary storage for various data, a nonvolatile memory such as a mask ROM (Read Only Memory), a flash memory, or an FeRAM (Ferroelectric RAM: ferroelectric memory), and so on (neither of them is shown), and functions as a computer. The CPU operates with a control program stored in the nonvolatile memory, thus the first control section 120 integrally controls the operation of the image supply device 100.

To the first control section 120, there are input various input operations from the input receiving section 121 and start signal information representing start of the projection of the record line RL1 in accordance with the progress of the competition. Upon input of the start signal information, the first control section 120 instructs the image data output section 135 to output the image data of the record line RL1.

The input receiving section 121 is configured including an operation input section 121a and a signal input section 121b as a start signal input section. The operation input section 121a is provided with a plurality of keys and so on for receiving a variety of input operations to the image supply device 100. As the keys provided to the operation input section 121a, there can be cited a “power key” for switching ON/OFF the power supply, an “image output key” for starting the output of the image data of the record line RL1, and so on.

When the user operates the operation input section 121a, the operation input section 121a outputs an operation signal corresponding to the operation content by the user to the first control section 120. It should be noted that the operation input section 121a can be arranged to have a configuration including a remote control signal receiving section (not shown) and a remote controller (not shown) capable of performing remote control. In this case, the remote controller emits the operation signal of, for example, an infrared ray corresponding to the operation content of the user, and then the remote control signal receiving section receives the operation signal and transmits it to the first control section 120.

The signal input section 121b is provided with a signal input terminal for inputting the start signal, which is transmitted by the starting pistol SP and is then received by the timing system TS. The signal input terminal is, for example, a signal input terminal compliant with a serial communication standard such as RS-232C. When the start signal is input to such a signal input terminal, the signal input section 121b outputs the start signal information to the first control section 120.

The record line image storage section 130 is configured including a nonvolatile memory, and stores the image data (the video data) of the record line RL1 indicating the midway progress and the result of a predetermined record (the world record of the 100-meter dash in the present embodiment) in the competition. The record line image storage section 130 outputs the image data of the record line RL1 to the image data output section 135.

It is assumed that the record line RL1 has a specific color (e.g., yellow), and is an image of a single “straight line” roughly perpendicular to all of the separate lanes SL. In the present embodiment, the portion other than the “straight line” to be projected is arranged to be an image showing a black plane image. When projected on the tracks CS by the projector 200, the image data of the record line RL1 forms a yellow line moving from the start line L1 toward the finish line L2 of the stadium in accordance with the midway progress and the result of the world record.

The image data output section 135 inputs the image data of the record line RL1 from the record line image storage section 130 based on the instruction of the first control section 120. Then, it outputs the image data to the projector 200 via the cable CB. It should be noted that the cable CB is not limited providing it is a cable which connects the image supply device 100 and the projector 200 to each other and capable of transmitting the image data such as an analog RGB cable or a video cable.

Due to such a configuration, the first control section 120 of the image supply device 100 issues an instruction to the image data output section 135 to output the image data of the record line RL1 to the projector 200 upon input of the start signal information from the signal input section 121b.

The projector 200 is provided with an image projection section 210, a second control section 220, an operation receiving section 221, a light source control section 222, an image data input section 230, an image processing section 231, and so on.

The image projection section 210 is provided with a light source 211 formed of a discharge light source such as a super-high pressure mercury lamp or a metal halide lamp, or of a solid-state light source such as an LED (Light Emitting Diode), a liquid crystal light valve 212 as a light modulation device, a projection lens 213, and a light valve drive section 214 for driving the liquid crystal light valve 212.

The liquid crystal light valve 212 is composed of, for example, a transmissive liquid crystal panel having a liquid crystal material encapsulated between a pair of transparent substrates. When the light valve drive section 214 drives each pixel of the liquid crystal light valve 212 by applying a drive voltage, which corresponds to the image signal, to the pixel, the pixel transmits the source light with the transmission factor corresponding to the image signal.

The light emitted from the light source 211 is modulated while being transmitted through the liquid crystal light valve 212, and the projection lens 213 projects the light thus modulated, thereby displaying the image corresponding to the image data on the tracks CS (ground).

The second control section 220 is provided with a CPU, a RAM used as a temporary storage for various data, a nonvolatile memory such as a mask ROM, a flash memory, or an FeRAM, and so on (neither of them is shown), and functions as a computer. The CPU operates with a control program stored in the nonvolatile memory, thus the second control section 220 integrally controls the operation of the projector 200.

The operation receiving section 221 is provided with a plurality of keys and so on for receiving a variety of input operations to the projector 200. As the keys provided to the operation receiving section 221, there can be cited, for example, a “power key” for switching ON/OFF the power, an “input switching key” for switching input source, a “menu key” for switching display/nondisplay of the menu screen for performing various settings, a “cursor key” used for moving the cursor in the menu screen, and a “determination key” for determining the various settings.

When the user operates the operation receiving section 221, the operation receiving section 221 outputs an operation signal corresponding to the operation content by the user to the second control section 220. It should be noted that the operation receiving section 221 can be arranged to have a configuration including a remote control signal receiving section (not shown) and a remote controller (not shown) capable of performing remote control. In this case, the remote controller emits the operation signal of, for example, an infrared ray corresponding to the operation content of the user, and then the remote control signal receiving section receives the operation signal and transmits it to the second control section 220.

The light source control section 222 controls supply and stop of the power to the light source 211 based on the instruction from the second control section 220, thus switching lighting and extinction of the light source 211.

The image data input section 230 is provided with a variety of types of image input terminals for performing connection via cables CB to external devices for supplying an image such as the image supply device 100, a personal computer, a video playback device, a memory card, an USB (Universal Serial Bus) storage, or a digital camera, and the image data is input thereto from devices for supplying an image. The image data input section 230 converts the image data thus input into image data information with a format, which can be processed by the image processing section 231, and then outputs it to the image processing section 231.

Based on the instructions from the second control section 220, the image processing section 231 executes various image quality control such as an adjustment of brightness, contrast, sharpness, or color, or gamma correction on the image data information input from the image data input section 230. Further, the image processing section 231 performs the process of superimposing an OSD (on-screen display) image on the image data information if necessary. The image processing section 231 outputs the image data information, on which the adjustment and the process described above are performed, to the light valve drive section 214.

The light valve drive section 214 drives the liquid crystal light valve 212 with the image data information input thereto. As a result, the image based on the image data is projected from the image projection section 210 to the tracks CS.

Due to such a configuration, the second control section 220 of the projector 200 issues the instructions to the light source control section 222 and the image processing section 231 to thereby make the image projection section 210 project the image of the record line RL1 based on the image data input thereto.

In the image projection system 1 described above, the image supply device 100 starts to output the image data of the record line RL1 of the world record to the projector 200 upon input of the start signal from the timing system TS. Then, the projector 200 can project the record line RL1 of the world record based on the image data input thereto on the tracks CS.

According to the first embodiment described above, the following advantages can be obtained.

(1) In the image projection system 1, when the start signal is input from the starting pistol SP via the timing system TS, the image supply device 100 outputs the image data of the record line RL1 as the video data indicating the world record in the 100-meter dash to the projector 200, and then the projector 200 projects the record line RL1 on the tracks CS based on the image data. Thus, by viewing the record line RL1 projected on the tracks CS, the audience watching the competition in the stadium can recognize the world record. Further, it becomes possible for the audience of the competition to advantageously watch the competition while comparing the competition states (the states during the competition) of the athletes H1, H2, H3, and H4 and the video image of the record line RL1 showing the midway progress and the result of the world record with each other. Further, it becomes possible for the audience of the competition to advantageously recognize whether or not the world record is broken without waiting until the measurement result is issued after the competition by comparing the athletes H1, H2, H3, and H4 and the record line RL1 with each other.

(2) The world record projected by the image projection system 1 on the tracks CS is shown as the record line RL1, namely a “straight line.” Thus, the audience of the competition can easily compare the competition states (the running positions) of the athletes H1, H2, H3, and H4 and the record line RL1 with each other. In other words, it becomes possible to advantageously view whether or not each of the athletes exceeds the world record with ease.

(3) By the image projection system 1 projecting the record line RL1 on the tracks CS, it becomes possible for the athletes H1, H2, H3, and H4 to compare the world record and their own competition states with each other. Therefore, the athletes H1, H2, H3, and H4 can advantageously perform the race while viewing the record line RL1 as a target. Further, by projecting such a record line RL1 on the tracks CS when performing the exercise of the competition, it becomes possible to advantageously view the target of the exercise. On this occasion, it is also possible to project the image of a line based on the target record provided to the athlete instead of the record measured in advance such as the world record.

### Second Embodiment

Hereinafter, a second embodiment will be explained.

In the image projection system 2 according to the second embodiment, the image supply device 100B generates the image data of the record line RL1 and then outputs it to the projector 200, and the projector 200 projects the image of the record line RL1 on the tracks CS based on the image data input thereto.

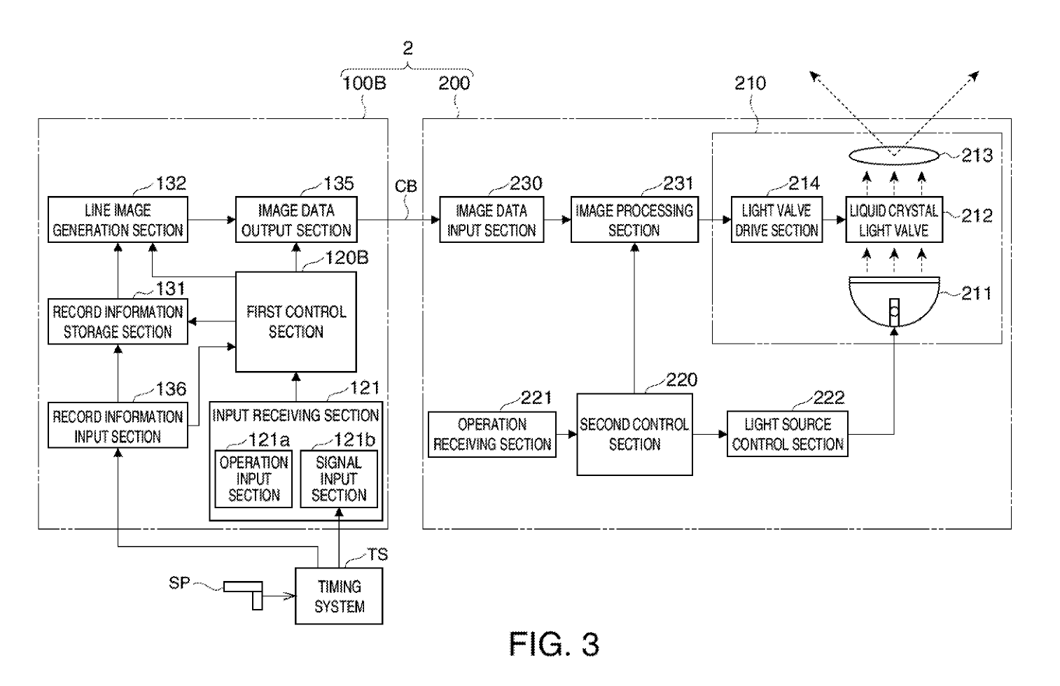

FIG. 3 is a block diagram showing a schematic configuration of the image projection system 2 according to the second embodiment. The internal configuration of the image projection system 2 will be explained using FIG. 3.

Hereinafter, differences from the first embodiment will be explained.

It is assumed that the image supply device 100B of the image projection system 2 according to the present embodiment is not provided with the record line image storage section 130, which is provided to the image supply device 100 of the image projection system 1 according to the first embodiment shown in FIG. 2. Further, it is assumed that the image supply device 100B is provided with a record information storage section 131 as a storage section, a line image generation section 132 as an image generation section, and a record information input section 136. Further, the control performed by the first control section 120B is different from that of the first control section 120 of the image supply device 100 according to the first embodiment. The other constituents of the image supply device 100B are the same as those of the image supply device 100 according to the first embodiment. Further, the same constituents are denoted by the same reference symbols. Further, it is assumed that the configuration of the projector 200 is the same as that of the first embodiment, and the constituents are denoted by the same reference symbols, respectively.

The record information storage section 131 is configured including a nonvolatile memory, and stores progress record information as the record information representing the midway progress and the result of a predetermined record (the world record of the 100-meter dash in the present embodiment) in the competition. The record information storage section 131 stores the information of the athletic event, the record time (the world record time) as the result, information of the midway progress of the competition, and so on. Such progress record information is written in the record information storage section 131 by the record information input section 136. Then, based on the instruction from the first control section 120B, the record information storage section 131 outputs the progress record information to the line image generation section 132.

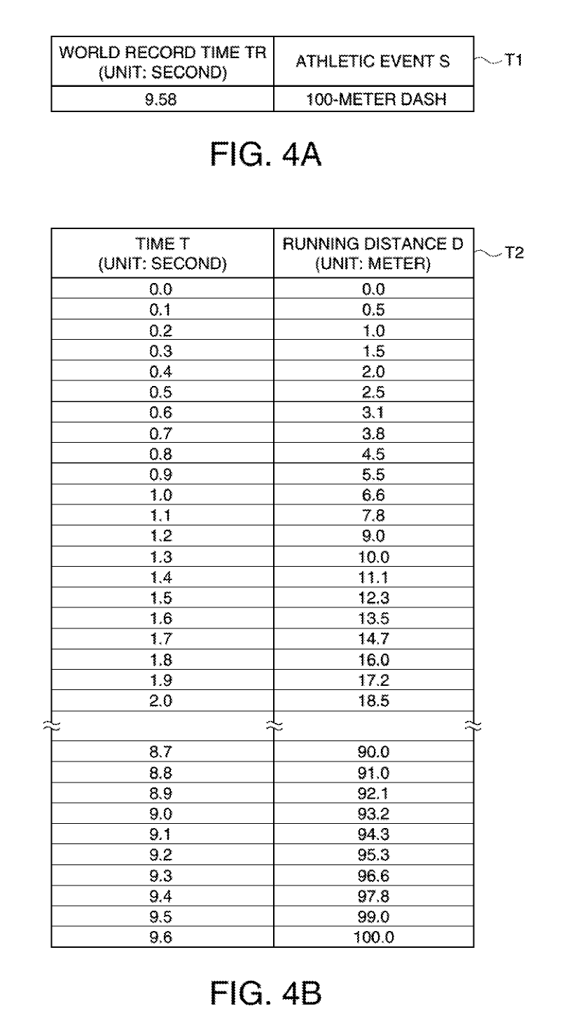

FIG. 4 is an explanatory diagram of the progress record information wherein FIG. 4(a) is a table storing an athletic event and the world record time, and FIG. 4(b) is a table storing the progress information of the competition.

As shown in FIG. 4(a), the 100-meter dash is stored in the table T1 as the athletic event S, and further, the information of 9.58 seconds is stored as the world record time TR. Further, as shown in FIG. 4(b), the table T2 stores the correspondence between the time T and the running distance D as the information of the midway progress of the competition. In the present embodiment, the table T2 stores the running distance D every 0.1 second. It should be noted that the time interval in the table T2 is not limited to 0.1 second.

Returning to FIG. 3, based on the instruction of the first control section 120B, the line image generation section 132 generates the image data of the record line RL1 in accordance with the progress record information input from the record information storage section 131, and then outputs it to the image data output section 135. Specifically, the line image generation section 132 generates the image of the record line RL1 based on the tables T1, T2 shown in FIG. 4. The line image generation section 132 performs an interpolation process between the information (data) of the table T2 to thereby convert it into continuous data. Then, it generates the video data of the record line RL1 moving continuously based on the continuous data. It is assumed that the record line RL1 has a specific color (e.g., yellow), and is an image of a single line (a straight line) roughly perpendicular to all of the separate lanes SL indicating the tracks CS. When output from the image data output section 135 to the projector 200, and then projected on the tracks CS by the projector 200, the image data of the record line RL1 is displayed as a yellow line moving from the start line L1 toward the finish line L2 of the stadium in accordance with the world record.

The record information input section 136 is provided with an information input terminal for inputting the progress record information from the timing system TS. The information input terminal is, for example, an input terminal compliant with a serial communication standard such as RS-232C. When the progress record information is input to such an input terminal, the record information input section 136 stores the progress record information in the record information storage section 131, and then further gives notice to the first control section 120B. It should be noted that in the present embodiment, the timing system TS makes it possible to measure and then output the progress record information.

Due to such a configuration, the first control section 120B of the image supply device 100B instructs the record information storage section 131 to output the progress record information to the line image generation section 132 when receiving the notice from the record information input section 136. Then, the first control section 120B instructs the line image generation section 132 to generate the image data of the record line RL1. Further, the first control section 120B issues an instruction to the image data output section 135 to output the image data of the record line RL1 to the projector 200 upon input of the start signal information from the signal input section 121b.

In the image projection system 2 described above, the image supply device 100B generates the image data of the record line RL1 of the world record upon input of the progress record information of the world record from the timing system TS. Then, the image supply device 100B starts to output the image data of the record line RL1 to the projector 200 upon reception of the start signal from the timing system TS. The projector 200 can project the record line RL1 based on the image data input thereto on the tracks CS.

According to the second embodiment described above, advantages substantially the same as the advantages (2) and (3) of the first embodiment can be obtained. The following advantages can additionally be obtained.

(1) The image supply device 100B of the image projection system 2 generates the image data as the video data of the record line RL1 based on the progress record information of the world record in the 100-meter dash. When the start signal is input from the starting pistol SP via the timing system TS, the image supply device 100B starts to output the image data of the record line RL1 thus generated, and then the projector 200 projects the record line RL1 on the tracks CS based on the image data. Thus, the audience watching the competition in the stadium can recognize the world record. In other words, it becomes possible for the audience of the competition to advantageously watch and enjoy the competition while comparing the competition states (the states during the competition) of the athletes H1, H2, H3, and H4 and the record line RL1 showing the midway progress and the result of the world record with each other. Further, it becomes possible for the audience of the competition to advantageously recognize whether or not the world record is broken without waiting until the measurement result is issued after the competition by comparing the athletes and the record line RL1 with each other.

(2) In the image projection system 2, if the world record is broken, it is possible for the image supply device 100B to input the renewed progress record information from the timing system TS and store it, and generate the image data of the new record line RL1 using the line image generation section 132. Then, the projector 200 projects the record line RL1 based on the new image data on the tracks CS. Thus, even in the case in which the world record is broken in, for example, the semifinal, the new record line RL1 can advantageously be projected in the final.

### Third Embodiment

Hereinafter, a third embodiment will be explained.

In the third embodiment, an image projection system for projecting an image of a line representing the world record as a predetermined record in the long jump (running broad jump) on the ground will be explained.

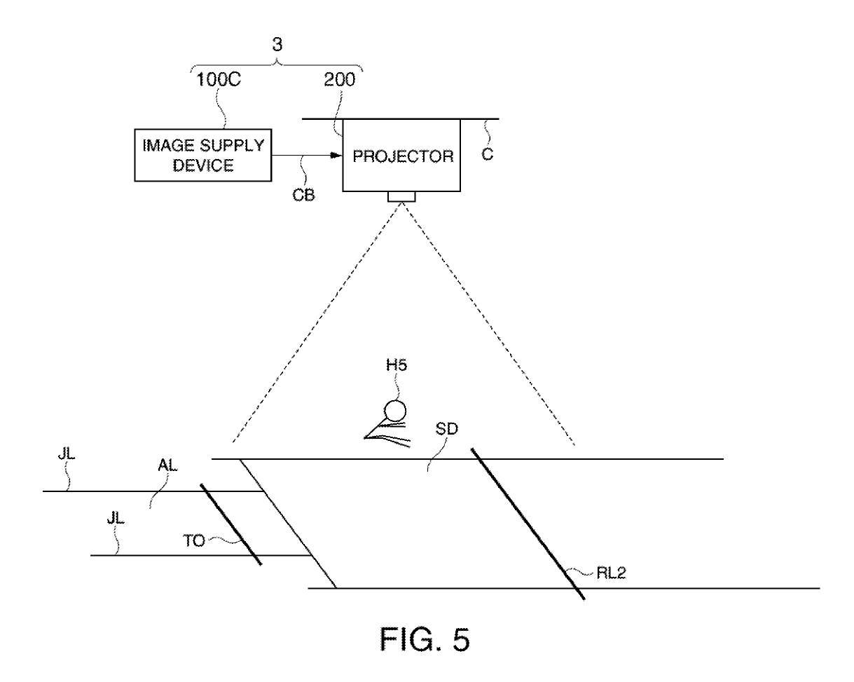

FIG. 5 is an explanatory diagram of a stadium of the long jump where the image projection system 3 according to the third embodiment projects the image of the world record line. As shown in FIG. 5, the image projection system 3 according to the present embodiment is composed of the image supply device 100C and the projector 200. Further, FIG. 5 shows a line (hereinafter referred to as a “record line RL2”) representing the world record, run-up lanes JL for indicating the runway AL, a takeoff line TO, a sandpit SD, and an athlete H5 jumping.

In the present embodiment, it is assumed that the stadium is an indoor athletics stadium, and the run-up lanes JL, the takeoff line TO are disposed on the ground. The athlete H5 runs the runway AL and then jumps from the takeoff line TO.

When a predetermined operation is performed, the image supply device 100C outputs the image data of the record line RL2 to the projector 200 via a cable CB. The projector 200 projects the image of the record line RL2 on the sand pit SD based on the image data of the record line RL2 thus input. It should be noted that the projector 200 is installed to the ceiling C of the stadium so as to face to the ground, and is arranged to be able to project the image on the sand pit SD of the stadium.

As shown in FIG. 5, the record line RL2 is a line roughly parallel to the takeoff line TO. It is assumed that the image data of the record line RL2 is the image data formed based on the jumping record of the world record holder of the long jump.

As described above, the image projection system 3 can project the record line RL2 of the world record on the sand pit SD in the competition.

Then, the image supply device 100C and the projector 200 provided to the image projection system 3 according to the present embodiment will be explained.

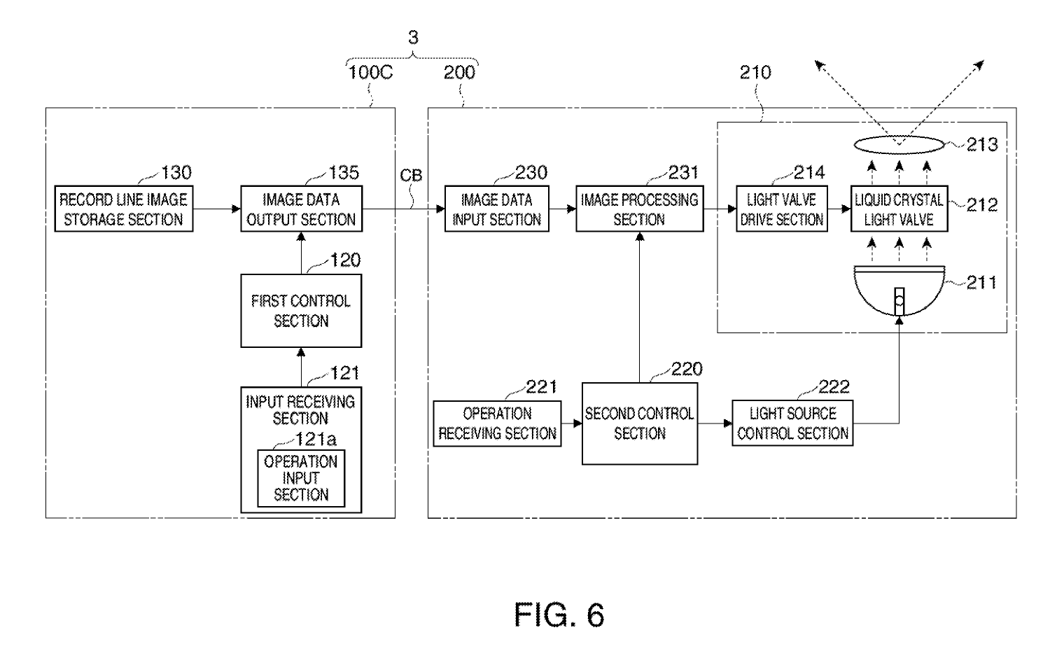

FIG. 6 is a block diagram showing a schematic configuration of the image supply device 100C and the projector 200 according to the present embodiment. The internal configuration of the image projection system 3 will be explained using FIG. 6.

Hereinafter, differences from the first embodiment will be explained.

It is assumed that the image supply device 100C of the image projection system 3 according to the present embodiment is not provided with the signal input section 121b of the input receiving section 121, which is provided to the image supply device 100 of the image projection system 1 according to the first embodiment shown in FIG. 2. The other constituents of the image supply device 100C are the same as those of the image supply device 100 according to the first embodiment. Further, the same constituents are denoted by the same reference symbols. Further, it is assumed that the configuration of the projector 200 is the same as that of the first embodiment, and the constituents are denoted by the same reference symbols, respectively.

The input receiving section 121 is configured including the operation input section 121a. The operation input section 121a is provided with a plurality of keys and so on for receiving a variety of input operations to the image supply device 100C. As the keys provided to the operation input section 121a, there can be cited a “power key” for switching ON/OFF the power supply, an “image output key” for starting the output of the image data of the record line RL2, and so on.

When the user operates the operation input section 121a, the operation input section 121a outputs the operation signal corresponding to the operation content by the user to the first control section 120. It should be noted that the operation input section 121a can be arranged to have a configuration including a remote control signal receiving section (not shown) and a remote controller (not shown) capable of performing remote control. In this case, the remote controller emits the operation signal of, for example, an infrared ray corresponding to the operation content of the user, and then the remote control signal receiving section receives the operation signal and transmits it to the first control section 120.

The record line image storage section 130 is configured including a nonvolatile memory, and stores the image data of the record line RL2 indicating a static predetermined record (the world record of the long jump in the present embodiment) in the competition. The record line image storage section 130 outputs the image data of the record line RL2 to the image data output section 135. It is assumed that the record line RL2 is an image of a single “straight line” having a specific color (e.g., yellow). In the present embodiment, the portion other than the “straight line” to be projected is arranged to be an image showing a black plane image.

The image data output section 135 inputs the image data of the record line RL2 from the record line image storage section 130 based on the instruction of the first control section 120. Then, it outputs the image data to the projector 200 via the cable CB.

Due to such a configuration, the first control section 120 of the image supply device 100C issues an instruction to the image data output section 135 to output the image data of the record line RL2 to the projector 200 upon input of the operation signal of the image output key from the operation input section 121a.

In the image projection system 3 described above, the image supply device 100C starts to output the image data of the record line RL2 of the world record to the projector 200 when the user holds down the image output key provided to the operation input section 121a. The projector 200 can project the static record line RL2 of the world record based on the image data input thereto on the sand pit SD.

According to the third embodiment described above, the following advantages can be obtained.

(1) In the image projection system 3, the image supply device 100C outputs the image data of the record line RL2 indicating the world record in the long jump to the projector 200, and the projector 200 projects the record line RL2 on the sandpit SD based on the image data. Thus, by viewing the record line RL2 projected on the sand pit SD, the audience watching the competition in the stadium can recognize the world record. In other words, it becomes possible for the audience of the competition to advantageously watch and enjoy the competition while comparing the competition state of the athlete H5 and the record line RL2 with each other. Further, it becomes possible for the audience of the competition to advantageously recognize whether or not the world record is broken without waiting until the measurement result is issued after the competition by comparing the athletes and the record line RL2 with each other.

(2) The world record projected by the image projection system 3 on the sand pit SD is shown as the record line RL2, namely a “straight line.” Thus, it becomes possible for the audience of the competition to watch the competition while comparing the competition state of the athlete H5 and the record line RL2 with each other, and therefore, it advantageously becomes possible to easily view whether or not the athlete H5 exceeds the world record.

(3) By the image projection system 3 projecting the record line RL2 on the sand pit SD, it becomes possible for the athlete H5 to compare the world record and his or her own competition state with each other. Therefore, the athlete H5 can advantageously perform the competition while viewing the record line RL2 as a target. Further, by projecting such a record line RL2 on the sandpit SD when performing the exercise of the competition, it becomes possible to advantageously view the target of the exercise.

It should be noted that the invention is not limited to the embodiments described above, but can be put into practice with various modifications or improvements. Some modified examples will be described below.

### Modified Example 1

Although in the embodiments the 100-meter dash and the long jump are explained, the invention is not limited thereto, but can also be applied to other athletic events. It can also be applied to, for example, the swimming, the shot put, and the javelin. In the case of the swimming, by projecting the record line of the world record on the poolside, the audience of the competition can view the record line.

### Modified Example 2

Although in the embodiments described above it is assumed that the image projection system 1, 2, 3 displays the world record by the “straight line” as the record line RL1, RL2, the invention is not limited thereto. It is possible to display it as other figures such as a circle, a triangle, or a rectangle, for example. Further, in the athletic event such as the shot put or the javelin, it can also be indicated by a circular arc, and the landing point of the thrown object can be indicated by a figure such as a circle, a triangle, or a rectangle described above. Such display can also be applied to the display of the landing point in the jumping event.

### Modified Example 3

Although it is assumed in the embodiments described above that the predetermined record in the image projection system 1, 2, 3 is the world record, the invention is not limited thereto. It is also possible to assume that the record is the Japanese record, a tournament record, or the like. Further, it is also possible to assume that the record is a record of an average value such as the national average.

### Modified Example 4

Although in the embodiments described above, it is assumed that the image projection system 1, 2, 3 stores the predetermined record of a specific athletic event, it is also possible to assume that the records of a plurality of athletic events can be stored. In the case of storing a plurality of records as described above, it is desirable to make the user select the desired record using the input receiving section 121, and to make the first control section 120, 120B select the image data of the record line thus selected.

### Modified Example 5

Although in the embodiments described above it is assumed that the image projection system 1, 2, 3 projects the single record line RL1 (or the record line RL2), it is also possible to project a plurality of record lines. For example, it is also possible to project both of the world record and the Japanese record. According to this method, it is possible for the audience of the competition to watch and enjoy the competition while comparing the competition state of the athlete with both of the record lines of the world record and the Japanese record.

### Modified Example 6

Although in the second embodiment it is assumed that the image projection system 2 stores the midway progress information of the competition in the record information storage section 131 as the table T2, it is also possible to store it as a function expressing the relationship between the time T and the running distance D.

### Modified Example 7

Although in the second embodiment it is assumed that the image projection system 2 stores the midway progress information of the competition in the record information storage section 131 as the table T2, it is also possible to arrange that the midway progress information of the competition is not stored. In this case, the image data is generated assuming that the record line RL1 moves in a uniform motion. According to this process, the process of the line image generation section 132 can be simplified.

### Modified Example 8

Although in the first embodiment and the second embodiment described above it is assumed that the signal input terminal the signal input section 121b has is the signal input terminal compliant with the serial communication standard such as RS-232C, the invention is not limited thereto. The communication such as USB or IEEE (Institute of Electrical and Electronic Engineers) 1394 can be adopted, or the IP network communication, or the communication using the wireless communication can also be adopted.

### Modified Example 9

Although in the second embodiment described above it is assumed that the information input terminal the record information input section 136 has is the input terminal compliant with the serial communication standard such as RS-232C, the invention is not limited thereto. The communication such as USB or IEEE 1394 can be adopted, or the IP network communication, or the communication using the wireless communication can also be adopted.

### Modified Example 10

Although in the third embodiment described above, there is described the example in which the input receiving section 121 of the image supply device 100C does not include the signal input section 121b, the invention is not limited thereto. By configuring, for example, so that a signal from takeoff detection means (not shown) provided to the runway AL is input to the signal input section 121b for detecting the takeoff motion of the athlete H5, it becomes possible to dynamically project the record line RL2.

### Modified Example 11

Although in the embodiments described above it is assumed that the projector 200 is installed to the ceiling C of the stadium, it is also possible to install the projector 200 so as to be suspended using a crane or a certain structure providing the stadium is an open-air stadium.

### Modified Example 12

Although the projector 200 of the embodiments described above uses the transmissive liquid crystal light valve 212 as the light modulation device, it is also possible to use a reflective light modulation device such as a reflective liquid crystal light valve. Further, it is also possible to use a micromirror array device for modulating the light emitted from the light source by controlling the emission direction of the incident light for every micromirror as a pixel.

### DESCRIPTION OF REFERENCE NUMERALS AND SIGNS

1, 2, 3 image projection system
100, 100B, 100C image supply device
120, 120B first control section
121 input receiving section
121a operation input section
121b signal input section
130 record line image storage section
131 record information storage section
132 line image generation section
135 image data output section
136 record information input section
200 projector
210 image projection section
211 light source
212 liquid crystal light valve
213 projection lens
214 light valve drive section
220 second control section
221 operation receiving section
222 light source control section
230 image data input section
231 image processing section
CB cable
TS timing system
SP starting pistol
ST starter
RL1, RL2 record line
SL separate lane
CS track
L1 start line
L2 finish line
H1, H2, H3, H4, H5 athlete
C ceiling
T1, T2 table
JL run-up lane
AL runway
TO takeoff line
SD sand pit

1. An image projection system comprising:
an image supply device; and
a projector,
wherein the image projection system projects an image of a figure adapted to represent a predetermined record in a competition on a floor or a ground of a stadium,
the image supply device includes
a storage section adapted to store record information representing the predetermined record, and
an image data output section adapted to output image data based on the record information to the projector, and
the projector includes
an image data input section adapted to receive input of the image data, and
an image projection section adapted to project the image of the figure based on the image data input to the image data input section.

2. The image projection system according to claim 1, wherein
the image supply device further includes
a start signal input section to which a start signal indicating start of projection of the figure is input, and
a control section adapted to make the image data output section start output of the image data upon input of the start signal to the start signal input section.

3. The image projection system according to claim 1, wherein
the record information stored in the storage section of the image supply device is a video data of the figure representing a midway progress and a result of the predetermined record in the competition, and
the image data output section outputs the video data to the projector as the image data.

4. The image projection system according to claim 1, wherein
the record information stored in the storage section of the image supply device is progress record information representing a midway progress and a result of the predetermined record in the competition,
the image supply device further includes an image generation section adapted to generate video data of the figure representing the midway progress and the result of the predetermined record in the competition based on the progress record information stored in the storage section, and
the image data output section outputs the video data generated by the image generation section to the projector as the image data.

5. The image projection system according to claim 1, wherein the image of the figure is an image of a line.

6. A method of controlling an image projection system including an image supply device and a projector, the image supply device including a storage section adapted to store record information representing a predetermined record in the competition, and the image projection system projecting an image of a figure adapted to represent the predetermined record based on image data based on the record information on a floor or a ground of a stadium, the method comprising:
an image data output step in which the image supply device outputs the image data based on the record information to the projector;
an image data input step in which the projector receives input of the image data; and
an image projection step in which the projector projects the image of the figure based on the image data input by the image data input step.

7. The image projection system according to claim 2, wherein
the record information stored in the storage section of the image supply device is progress record information representing a midway progress and a result of the predetermined record in the competition,
the image supply device further includes an image generation section adapted to generate video data of the figure representing the midway progress and the result of the predetermined record in the competition based on the progress record information stored in the storage section, and
the image data output section outputs the video data generated by the image generation section to the projector as the image data.

8. The image projection system according to claim 7, wherein the image of the figure is an image of a line.

9. The image projection system according to claim 2, wherein
the record information stored in the storage section of the image supply device is a video data of the figure representing a midway progress and a result of the predetermined record in the competition, and
the image data output section outputs the video data to the projector as the image data.

10. The image projection system according to claim 9, wherein the image of the figure is an image of a line.

11. The image projection system according to claim 2, wherein the image of the figure is an image of a line.

12. The image projection system according to claim 3, wherein the image of the figure is an image of a line.

13. The image projection system according to claim 4, wherein the image of the figure is an image of a line.
